(19) United States
(12) Patent Application Publication
(10) Pub. No.: US 2024/0018334 A1
(43) Pub. Date: Jan. 18, 2024

(54) POLYESTER NETWORKS FROM STRUCTURALLY SIMILAR MONOMERS: RECYCLABLE-BY-DESIGN AND UPCYCLABLE TO PHOTOPOLYMERS

(71) Applicant: UNIVERSITY OF UTAH RESEARCH FOUNDATION, Salt Lake City, UT (US)

(72) Inventors: Chen WANG, Salt Lake City, UT (US); Grant M. MUSGRAVE, Salt Lake City, UT (US)

(21) Appl. No.: 18/352,014

(22) Filed: Jul. 13, 2023

Related U.S. Application Data
(60) Provisional application No. 63/389,606, filed on Jul. 15, 2022.

(51) Int. Cl. C08J 11/26

(52) U.S. Cl. CPC C08J 11/26; C08J 2367/00

(57) ABSTRACT

Polyesters formed from epoxy and anhydride monomers, where both the epoxy and anhydride monomers include a single, e.g., cyclic backbone, so that upon depolymerization degradation, a singular monomer results, both from the epoxy and anhydride portions of the polymer. In an embodiment, such backbone may include a phthalic or other aromatic structure having dicarboxylate groups or a cycloaliphatic structure having dicarboxylate groups. The polyesters can be degraded under mild conditions with an alkali metal carbonate or alkaline earth metal catalyst. Upon such depolymerization (e.g., transesterification), the single resulting phthalic, other aromatic, or cycloaliphatic monomer can be repolymerized to produce a new polymer. Where degradation is carried out in an unsaturated alcohol, the resulting depolymerization product may be photopolymerizable.

### CROSS-REFERENCE TO RELATED APPLICATIONS

This application claims priority to and the benefit of U.S. Provisional Patent Application Ser. No. 63/389,606 entitled POLYESTER NETWORKS FROM STRUCTURALLY SIMILAR MONOMERS: RECYCABLE-BY-DESIGN AND UPCYCLABLE TO PHOTOPOLYMERS filed Jul. 15, 2022 which is herein incorporated by reference in its entirety.

### FIELD OF THE INVENTION

The present invention generally relates to recyclable polyesters.

### BACKGROUND

Epoxy-based polymer networks from step-growth polymerizations are ubiquitous in coatings, adhesives, and as matrices in composite materials. Particular dynamic covalent bonds designed into the network allow its degradation to small molecules and thus, enable chemical recycling, at least in theory. However, as a practical matter such degradation often requires elevated temperatures and costly chemicals, and the degradation results in a variety of small molecules, making recycling such materials difficult and expensive as a practical matter.

As such, there is a continuing need for alternative polymers and methods that might provide for improved recyclability, and/or upcyclability within a circular polymer economy.

### SUMMARY

The present disclosure provides crosslinked network polyesters from structurally similar epoxy and anhydride monomers, e.g., derived from phthalic acid or another similar cyclic backbone. Such polyesters can advantageously be degraded through transesterification reactions at ambient or near ambient conditions (e.g., low temperature, and atmospheric pressure) using an alkali metal carbonate or alkaline earth metal catalyst, resulting in a singular (e.g., phthalic ester) degradation product.

In addition, Applicant has demonstrated the ability to upcycle the network polyesters to photopolymers by a one-step depolymerization when a functional (e.g., unsaturated) alcohol is used during the transesterification degradation.

Broadly speaking, any of various dicarboxylate backbone monomers may be used. In an embodiment, an aromatic (e.g., phthalic) or cyclic aliphatic (e.g., cyclohexane) backbone may be present, so that upon transesterification degradation, a single degradation product results, exhibiting the phthalic or other aromatic, or cycloaliphatic backbone, which monomer can be polymerized again, or used as a feedstock for another chemical synthesis.

Degradation of such network polyesters, as well as various other polyesters (e.g., PET or others) is also shown using low temperature, mild condition reactions, using a variety of alkaline earth or alkali metal carbonates (e.g., potassium carbonate, cesium carbonate, rubidium carbonate). The higher atomic weight alkali metal carbonates (cesium carbonate and rubidium carbonate) work even better than potassium carbonate.

In an embodiment, the present methods and systems employ epoxy and anhydride monomers, where both of such are derived from phthalic or other aromatic and/or cycloaliphatic backbone components, so that when degraded (e.g., using a lower alcohol such as methanol and an alkali metal or alkaline earth carbonate catalyst such as potassium carbonate), the degradation products are all phthalic or other aromatic and/or cycloaliphatic molecules, rather than producing a variety of components that would require expensive separation prior to further use. Such aromatic monomers and/or cycloaliphatic monomers can be repolymerized, to produce a new polymer (i.e., recycling).

In an embodiment, a polyester is formed from epoxy and anhydride monomers, where both the epoxy and anhydride monomers include the same cyclic backbone such as (i) a phthalic or other aromatic structure having dicarboxylate groups, or (ii) a cycloaliphatic structure having dicarboxylate groups. Such a polyester can be degraded under mild conditions, using an alkali metal or alkaline earth metal catalyst, and when doing so, the result is a single cyclic backbone monomer, such as a single phthalic or other aromatic monomer, or a single cycloaliphatic monomer (depending on what cyclic backbone structure the epoxy and anhydride monomers were provided with). Such resulting single phthalic, other aromatic, or cycloaliphatic monomers can be repolymerized, to produce a new polymer, or used for other purposes (e.g., production of some other value added material from the resulting degraded monomers). While generally described as monomers resulting from the transesterification degradation, it will be appreciated that some dimers, trimers, or oligomers could result, depending on conditions, and the inclusion of such components is contemplated herein. The term monomer is used when referring to the degradation product, for simplicity.

In an embodiment, a method for recycling and/or upcycling a polyester formed from epoxy and anhydride monomers is also provided. Both the epoxy and anhydride monomers include a cyclic backbone such as (i) a phthalic or other aromatic structure having dicarboxylate groups, or (ii) a cycloaliphatic structure having dicarboxylate groups. The method includes degrading the polyester by contacting the polyester with a degradation composition including a lower alcohol (e.g., a C₁-C₆, or C₁-C₄ alcohol) and at least one of an alkali metal catalyst or an alkaline earth metal catalyst at mild temperature (e.g., no more than about 60° C., 50° C. or 35° C.) so as to produce a cyclic monomer, such as a single phthalic or other aromatic or a single cycloaliphatic monomer. The identity of the single degradation monomer product depends on the backbone structure of the selected epoxy and anhydride components (which include the same backbone structure). The resulting single phthalic, single aromatic, single cycloaliphatic or other single cyclic monomer can be repolymerized to produce a new polymer.

Another embodiment is directed to a method of manufacturing a polyester, the method including providing epoxy and anhydride monomers, where both the epoxy and anhydride monomers are selected to include the same cyclic backbone, such as either (i) a phthalic or other aromatic structure having dicarboxylate groups, or (ii) a cycloaliphatic structure having dicarboxylate groups. The method further includes polymerizing the epoxy and anhydride monomers to form a polyester that can be recycled or upcycled as described herein.

In any of the described embodiments, in an embodiment, the epoxy and anhydride monomers can both include aromatic structures.

In any of the described embodiments, in an embodiment, the epoxy and anhydride monomers can both include phthalic structures.

In any of the described embodiments, in an embodiment, the epoxy and anhydride monomers can both include cycloaliphatic (e.g., cyclohexane) structures.

In any of the described embodiments, in an embodiment, the polyester may not include a polymerization product of a dicarboxylate and a diol, such as polyethylene terephthalate (“PET”).

In any of the described embodiments, the depolymerization degradation can be carried out at a temperature of no greater than 60° C.

In any of the described embodiments, the depolymerization degradation can be carried out at a temperature of no greater than 50° C.

In any of the described embodiments, the depolymerization degradation can be carried out at a temperature of no greater than 35° C.

In any of the described embodiments, the lower alcohol used in the depolymerization degradation comprises a C₁-C₆ alcohol.

In any of the described embodiments, the lower alcohol used in the depolymerization degradation comprises a C₁-C₄ alcohol.

In any of the described embodiments, the lower alcohol used in the depolymerization degradation comprises methanol.

In any of the described embodiments, the alcohol used in the depolymerization degradation comprises a functional alcohol, with one or more unsaturated C-C bonds, which results in an upcycled degradation product, which can be used to produce a photopolymer. Examples of such unsaturated functional alcohols include, but are not limited to an allylic alcohol, or propargyl alcohol.

In any of the described embodiments, the depolymerization degradation is carried out in the presence of an alkaline earth metal carbonate catalyst, or an alkali metal carbonate catalyst. In an embodiment, an alkali metal carbonate other than potassium carbonate can be used.

In any of the described embodiments, the depolymerization degradation is carried out in the presence of cesium carbonate.

In any of the described embodiments, the depolymerization degradation is carried out in the presence of rubidium carbonate.

In any of the described embodiments, the depolymerization degradation is carried out in the presence of potassium carbonate.

In any of the described embodiments, the polymerization can include a tertiary co-monomer in addition to the epoxy and the anhydride. Such tertiary co-monomer can be a monofunctional polymerizable component, so as to terminate a polymerizing chain. The tertiary co-monomer can include an alkyl or other substituent chain, which can be selected in chain length to adjust Tg, modulus, or other characteristics of the resulting polymer.

Features from any of the disclosed embodiments may be used in combination with one another, without limitation. This summary is provided to introduce a selection of concepts in a simplified form that are further described below in the detailed description. This summary is not necessarily intended to identify key or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale.

FIG. 1A schematically illustrates typical network polyesters, synthesized by epoxy-anhydride polymerization.

FIG. 1B schematically illustrates exemplary network polyesters formed from structurally similar cyclic monomers, such as phthalic monomers (i.e., phthalic epoxies and phthalic anhydrides).

FIG. 2A shows FTIR confirmation of the complete polymerization between stoichiometric amounts of epoxy and anhydride from diglycidyl phthalate (“DGPH”) and phthalic anhydride (“PHA”).

FIG. 2B shows DSC results, evidencing a DGPH-PHA network polyester having a glass transition temperature (Tg) of 111±2° C.

FIG. 2C shows DMA results, evidencing a rubbery modulus of 13.1 MPa, and a glass transition temperature of 131° C.

FIG. 3 shows a ¹H NMR overlay of (a) diglycidyl phthalate (“DGPH”) (b) phthalic anhydride (“PHA”) (c) monomethyl phthalate (d) degraded DGPH-PHA polymer in methanol (e) degraded PH-0.6 Me in methanol and (f) standard dimethyl phthalate.

FIG. 4A schematically illustrates a reaction scheme for copolymerizing epoxy and anhydride with mono-acid/ester, as well as the degradation routes of the polymer with methanol, allyl alcohol, and propargyl alcohol.

FIG. 4B shows depolymerization degradation results for PHDG-PHA and PH-0.6 Me with saturated K₂CO₃ methanol solution at 23° C. under ambient pressure.

FIG. 4C shows depolymerization degradation results for Ph-0.6 Me in methanol by various catalysts, including Li₂CO₃, Na₂CO₃, K₂CO₃, Rb₂CO₃, and Cs₂CO₃, as well as a control group using no catalyst, at 23° C. under ambient pressure.

FIG. 4D shows depolymerization degradation kinetics for Ph-0.6 Me in methanol, allyl alcohol, and propargyl alcohol at 50° C.

FIG. 5A schematically illustrates an exemplary reaction scheme of thiol-ene photopolymerization from upcycled alkene and alkyne phthalates with a multifunctional thiol.

FIG. 5B shows FTIR spectra of the thiol-ene monomers and the resulting polymers.

FIG. 5C shows DMA data of the thiol-ene polymer that resulted from PETMP and recovered DAPH (left) and standard DAPH (right).

FIG. 6 schematically shows an exemplary closed-loop recycling scheme for phthalic or other cyclic carboxylates. The network polyesters depolymerize by methanolysis into glycerol and dimethyl phthalate, which can be subsequently converted to the same polymer. First, phthalic acid can be obtained by hydrolysis. Thereafter, phthalic acid can be converted to PHA and DGPH by dehydration and esterification with epichlorohydrin, respectively.

FIG. 7A schematically shows a reaction scheme similar to that of FIG. 1B, but where the monomers include a cyclohexane (“CH”) backbone, rather than the aromatic backbone of other illustrated examples.

FIG. 7B shows an FTIR overlay of (1) CH-anhydride, (2) CH-epoxy, and (3) CH polymer.

FIG. 7C shows DMA results for CH polymer.

FIG. 8A schematically shows an exemplary reaction scheme for transesterification reaction of PET with methanol catalyzed by rubidium carbonate or cesium carbonate.

FIG. 8B shows ¹H NMR data, evidencing the formation of dimethyl terephthalate in the degradation product.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

### I. Introduction

The present disclosure is directed to methods of use, methods of manufacture, and materials that employ epoxy and anhydride monomers, where both monomers are derived from aromatic (e.g., phthalic), cycloaliphatic (e.g., cyclohexane) or other cyclic components, so that when degraded (e.g., using an alcohol and an alkali metal or alkaline earth metal carbonate catalyst), the degradation products are all aromatic (e.g., phthalic), cycloaliphatic (e.g., cyclohexane) or other cyclic molecules, rather than resulting in a variety of components that would require expensive separation prior to further use. Such aromatic, cycloaliphatic or other cyclic monomers can be repolymerized, to produce a new polymer (i.e., recycling). In an embodiment, where an unsaturated alcohol is used during the degradation, the resulting monomers may be upcycled to produce photopolymers (i.e., polymers that are photopolymerizable), due to the presence of an unsaturated C—C bond in the resulting degradation product structure. Such materials are useful in free-radical mediated photopolymerizations, such as thiol-ene reactions. Such thiol-ene photopolymers are useful as a robust platform for fabrication of various coatings, biomaterials, polymers for stereolithographic 3D printing, etc.

In an embodiment, both the epoxy and anhydride monomers used to produce the easily recyclable polyester include a cyclic backbone such as (i) a phthalic or other aromatic structure having dicarboxylate groups, or (ii) a cycloaliphatic structure having dicarboxylate groups. Such a polyester can be degraded under mild conditions, e.g., at ambient or only slightly elevated temperature (e.g., no more than about 60° C., 50° C. or 35° C.), using an alcohol and an alkali metal or alkaline earth metal catalyst, and when doing so, the result is a single aromatic monomer, single cycloaliphatic monomer or other single cyclic monomer (depending on what backbone structure the epoxy and anhydride monomers were provided with). Such resulting single cyclic monomers can be repolymerized, to produce a new polymer, or used for other recycling purposes. As described, where the alcohol used in degradation is an unsaturated alcohol (e.g., including a C—C double bond, or a C—C triple bond), the resulting monomers can be photopolymerizable.

### II. Exemplary Compositions and Methods

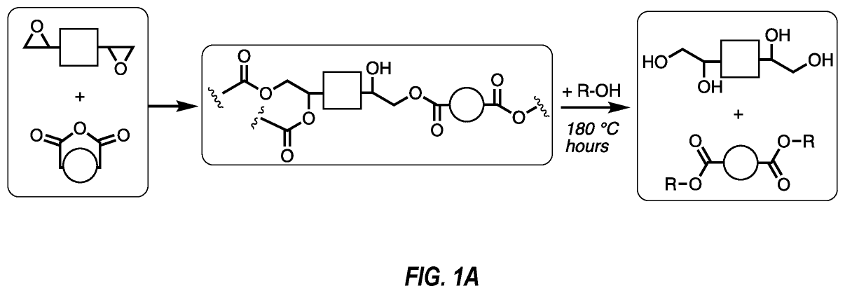

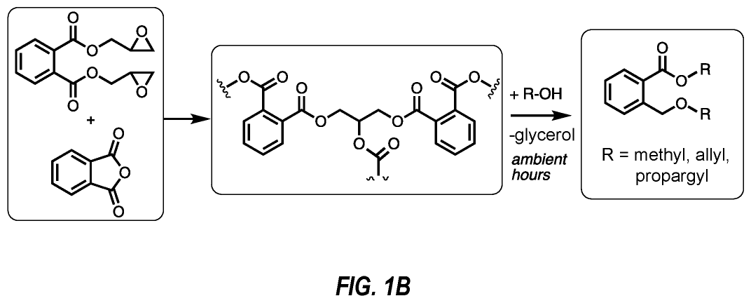

Network polymers, also known as crosslinked polymers, make up the most durable materials, including those found in adhesives, coatings, and fiber-reinforced composites. Epoxy resins are a popular type of crosslinked polymer. Epoxies can undergo step-growth polymerizations with thiols, amines, and anhydrides, forming C—S (thioether), C—N, and ester bonds, respectively. These co-monomers are often referred to as “hardeners.” The epoxy and the hardener's chemical structures are typically different and often strategically varied to tune the resulting polymer's properties. When above glass transition temperature (Tg), network polymers are “glassy” or stiff and elastic and do not flow. They also do not dissolve in solvents. As a result, unlike thermoplastic polymers which can be melted down or dissolved in a solvent, such network polymers cannot be straightforwardly recycled. One solution to make network polymers recyclable is to incorporate dynamic covalent bonds into the structure, that enable viscous flow by bond-exchange reactions or depolymerization by bond-cleavage reactions. FIG. 1A schematically illustrates an exemplary typical network polyester synthesized by step growth epoxy-anhydride polymerization. A network polyester results from a difunctional (or higher) epoxy and a cyclic anhydride monomer. Transesterification degradation reactions with an excess amount of alcohol can degrade the network polyester to a mixture of multifunctional polyol alcohols and difunctional esters, as shown. While such polymers can be degraded in alcohol at elevated temperature (e.g., 180° C. or higher), the degradation products result in a chemically complex “soup” including the multifunctional polyol alcohol derived from the epoxy portion of the polymer, and a difunctional ester derived from the anhydride portion of the polymer. The circles and squares shown in the epoxy and anhydride structures (and the resulting polymerized, and degradation product) of FIG. 1A may represent any of a wide variety of alkyl carbons, heteroatoms, or other constituents, as will be appreciated by those of skill in the art.

As illustrated in FIG. 1B, the present disclosure contemplates using phthalate or another cyclic-derived epoxy monomer and a similarly backboned phthalate or other cyclic anhydride to polymerize into a polyester that includes the cyclic backbones of the epoxy and anhydride monomer components. After the useful life of the product, both components are recovered as a difunctional ester exhibiting such cyclic backbone, after degradation of the polyester by transesterification reactions under mild reaction conditions. In other words, both the original epoxy moiety of the polyester and the anhydride moiety of the polyester degrade to produce the same difunctional ester, with a given cyclic backbone.

Carboxylic esters are of particular interest as a dynamic covalent bonded functional group for depolymerization for high-volume applications because of their abundance, and the demand for such materials. Carboxylic acids, anhydrides, and esters are among the most important petrochemicals and are being increasingly produced from renewable resources.

The present disclosure seeks to reduce the energy required in degrading network polyesters, to design such polyesters so that both moieties degrade to the same difunctional ester with a cyclic backbone, while also optionally enabling upcycling of the degraded molecules (e.g., to produce photopolymerizable components). For example, the present disclosure contemplates transesterification degradation of the described polyesters, under mild conditions, in the presence of an alcohol and a catalyst that comprises an alkali metal or alkaline earth metal carbonate salt. Examples of such carbonate salts include lithium carbonate, sodium carbonate, potassium carbonate, cesium carbonate, rubidium carbonate, beryllium carbonate, magnesium carbonate, calcium carbonate, strontium carbonate, or barium carbonate. Potassium carbonate, cesium carbonate, and rubidium carbonate work particularly well. Combinations of different carbonate salts could be used.

While the contemplated transesterification degradation can occur in the presence of a wide variety of alcohols, in an embodiment, a lower alcohol, e.g., having 1-6 or 1-4 carbon atoms is used. Examples include, but are not limited to methanol, ethanol, propanol, isopropanol, butanol, and the like. Aliphatic alcohols, having a single hydroxyl group, can be used. Advantageously inexpensive, relatively volatile alcohols can be used, as the temperature needed to achieve the desired degradation is relatively low. Of course, less volatile alcohols with higher numbers of carbon atoms could also be used, if desired.

Where upcycling is desired, an unsaturated alcohol (e.g., having a C—C double bond, or a C—C triple bond) such as allyl alcohol or propargyl alcohol can be used during transesterification degradation, to produce a diester with the cyclic backbone, that also includes reactive unsaturated C—C double or triple bonds that can react in a free-radical photopolymerization reaction. For example, this allows degradation of the contemplated network polyesters into unsaturated molecules for producing photopolymers, which are an increasingly important, high-value material used in additive manufacturing.

The present invention allows for circular, recycled use of phthalates or other cyclic molecules. Bisphenol A (BPA) based epoxy has been predominantly used in crosslinked epoxy polymers. When paired with aliphatic amines, epoxy-amine systems excel at modest viscosity, ample pot life, and modest-to-fast cure times. Often, epoxy-amine polymers are formulated to include a mixture of amines with various backbone structures, notably flexible linkages, to improve toughness. In the present disclosure, for step-growth polyesters with structural similarities, it is important that the properties can still be tuned. By incorporating various types and amounts of a tertiary component such as PHMEA with different alkyl chain lengths (e.g., see Table 1 of Example 2), the Tg and rubbery modulus of a given polymer can be adjusted. For example, the polymer backbone becomes more flexible when a longer alkyl tail in the PHMEA is used. It will be appreciated that other tertiary components other than PHMEA may alternatively be used, providing similar results. For example, PHMEA is a monofunctional polymerizable component, terminating the polymerizing chain. Other monofunctional polymerizable components could alternatively be used. The alkyl chain length of such monofunctional polymerizable component may be selected to be from 1 to 12, or from 1 to 8 or from 1 to 6 carbon atoms, depending on desired properties.

Many phthalic esters have been commercially produced, mostly used as plasticizers. The proposed synthesis using PHMEA as a tertiary component (in addition to the epoxy and anhydride) is advantageously straightforward and scalable. The included examples demonstrate the viability of phthalic polyesters as a robust platform with practical implementations for various thermoset applications. It is important to develop new, circular use of current, singly-used feedstock chemicals to enable a circular economy of polymer materials. For example, PHA is currently produced for use in phthalic esters for plasticizing polyvinyl chloride (“PVC”). Migration of phthalic plasticizers in PVC is a current significant environmental and human health concern. In addition, plasticized PVC as currently produced is used linearly (not cyclically) for only one life cycle. As such, the present disclosure can lower the barrier for the industry to adopt new polymer materials by taking advantage of much of the existing chemical infrastructure. Moreover, although currently PHA is typically produced by oxidizing o-xylene, a petrochemical derived from cracking crude oil, PHA is producible from renewable resources such as furan and maleic anhydride.

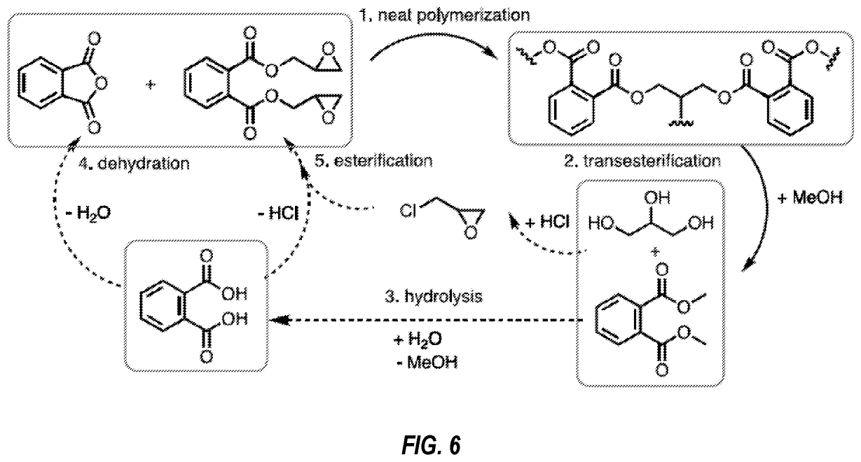

Closed-loop recycling of polymers is an exemplary scheme for achieving a circular economy of materials. This strategy has been demonstrated in linear (non-crosslinked) polymers, including PET, polylactone, polylactam, poly(cyclic acetal), and aliphatic polyesters. For cross-linked network polymers, separation of the constituent monomers is a significant problem. In the present disclosure, the structural similarity between the initial monomers simplifies or eliminates any separation needed for a closed-loop chemical recycling operation. As shown in FIG. 6, the glycidyl ester groups become glycerol after neat polymerization (step 1) and transesterification (step 2). Glycerol can be used as a feedstock to synthesize epichlorohydrin, a building block for epoxy monomers. Use of both PHA and DGPH result in dimethyl phthalate after the contemplated transesterification degradation, which can then be hydrolyzed into phthalic acid (step 3). PHA and DGPH can be reclaimed by dehydration (step 4) and esterification (step 5) reactions, respectively. The steps are readily scalable since they employ widely commercialized chemical conversions using readily available, inexpensive reagents.

### III. EXAMPLES

### Example 1

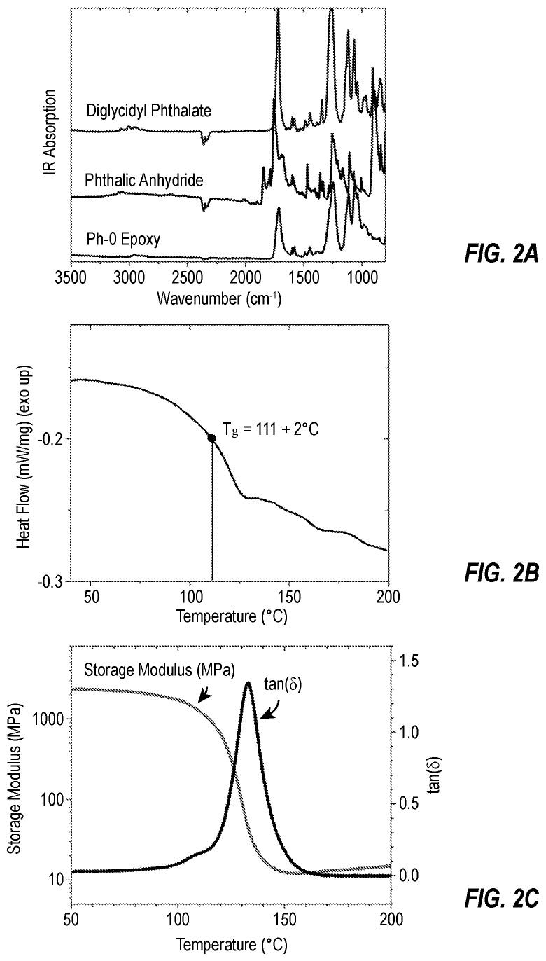

In this example, Applicant designed a stoichiometric polymerization reaction between two epoxy groups and one anhydride group. The employed components were diglycidyl phthalate (“DGPH”) and phthalic anhydride (“PHA”). Polymerization resulted in a stiff, glassy polymer. Since PHA has a melting temperature of 131° C., the PHA was maintained melted and homogenized by keeping the resin at 130° C., using 2-ethyl-4-methylimidazole (EMI, 1.0 wt % to monomers) as the catalyst. Under this condition, the polymerization was fully completed after 2 h, as confirmed by Fourier-transform infrared spectroscopy (“FTIR”), shown in FIG. 2A. Notably, the carbonyl peaks from DGPH and PHA were centered at 1720 cm⁻¹ and 1760 cm⁻¹, respectively. The polymer showed a single carbonyl peak at 1720 cm⁻¹, confirming the complete consumption of the anhydride monomer. We observed a Tg of 111±2° C. by Differential Scanning calorimetry (DSC), shown in FIG. 2B. The network architecture was confirmed by Dynamic Mechanical Analysis (“DMA”), where a rubbery modulus of 13.1 MPa and a Tg of 133° C. were observed, as shown in FIG. 2C.

Degradation of the DGPH-PHA network polyester was efficiently carried out by a transesterification reaction with excess methanol, catalyzed by K₂CO₃. Transesterification reactions between polyester and alcohols are typically carried out using a metal catalyst at elevated temperatures. Such elevated temperatures prohibit degradation using volatile lower alcohols such as methanol or ethanol under ambient pressure since the alcohols reach their boiling points under such conditions. Advantageously, the present process uses an alkali metal or alkaline earth metal carbonate (e.g., potassium carbonate), rather than a metal catalyst. Such is carried out at low temperature and atmospheric pressure to catalyze transesterification degradation of the crosslinked polyester in the presence of a volatile lower alcohol. It was surprising that the DGPH-PHA polymer, which exhibits a relatively high Tg and a cross-linked network architecture, was able to show complete degradation within 24 hours at a temperature of under 50° C. using a saturated K₂CO₃ methanol solution.

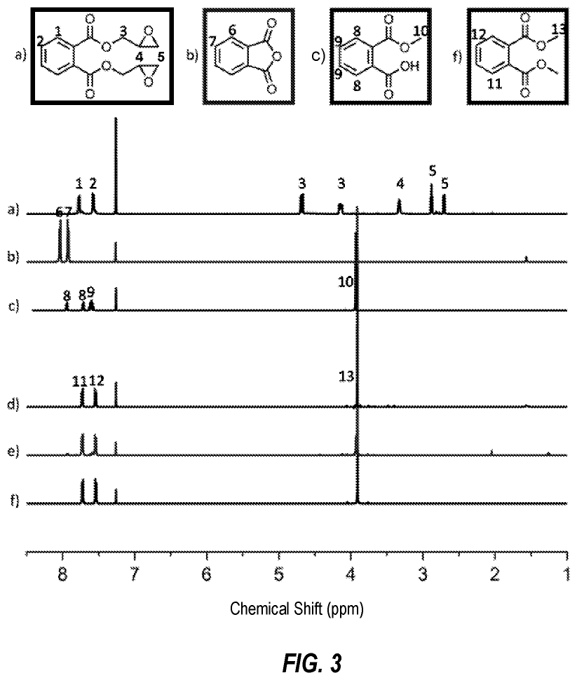

After evaporation of the volatile liquids, the remaining organic matter was characterized by ¹H NMR. The results of such are shown in FIG. 3. The NMR spectrum showed that the degraded molecule was dimethyl phthalate (DMPH). This observation confirmed that the epoxy-anhydride polymerization led to a cross-linked network polyester, and that the structural similarities from the initial monomers (i.e., they have the same phthalic backbone) led to a singular degradation product, exhibiting that same cyclic (e.g., phthalic) backbone.

It was recognized though, that some drawbacks exist. For example, PHA recrystallizes quickly, providing only a short time to process the mixed resin. In addition, it was observed that sometimes runaway reactions could occur when samples were overheated. More importantly, it was observed that the polymer properties could not be adjusted without changing the employed epoxy-anhydride stoichiometry.

### Example 2

Based on the results of Example 1, Applicant next sought to tune the properties of the polymer by including a copolymerizing monomer. Similar to the epoxy-anhydride polymerizations, an epoxy-carboxylic acid reaction proceeds through nucleophilic addition of the active proton (from the acid) to the oxirane ring of the epoxy. This example tested the hypothesis that phthalic mono-ester/mono-acid (“PHMEA”), when copolymerized into a step-growth network polyester, could be used to tune the properties of the polymer, by reducing crosslinking density. It was also hypothesized that such a tertiary component would also degrade to a phthalic ester after depolymerization. To test this hypothesis, a series of DGPH-PHA-PHMEA copolymers were prepared with varying amounts of PHMEA. The overall functional group stoichiometry was fixed at:

[epoxy]=2[anhydride]+[mono acid]

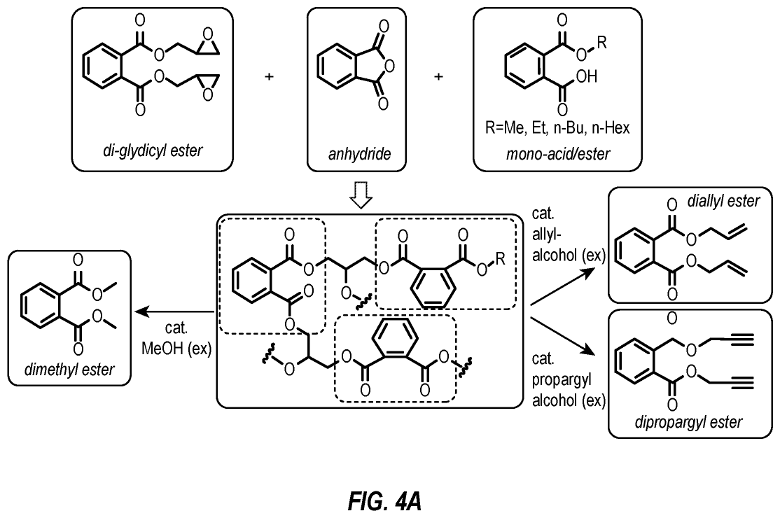

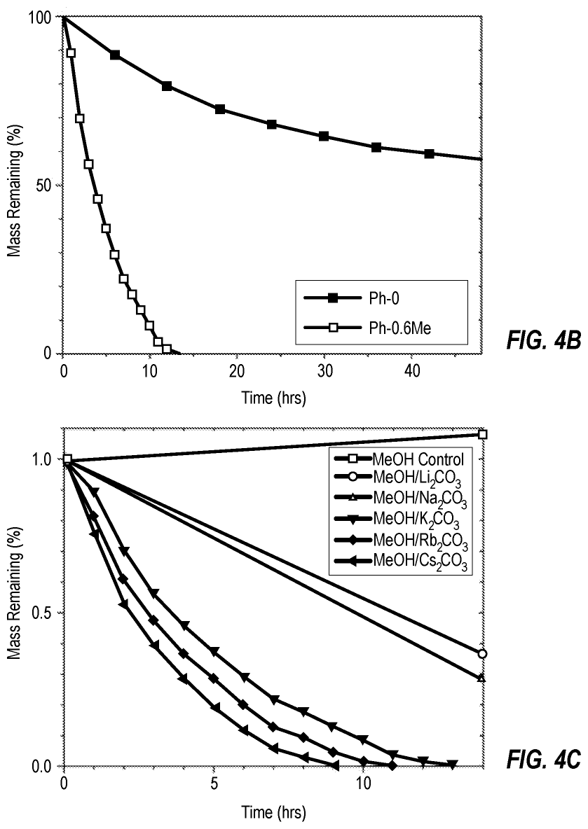

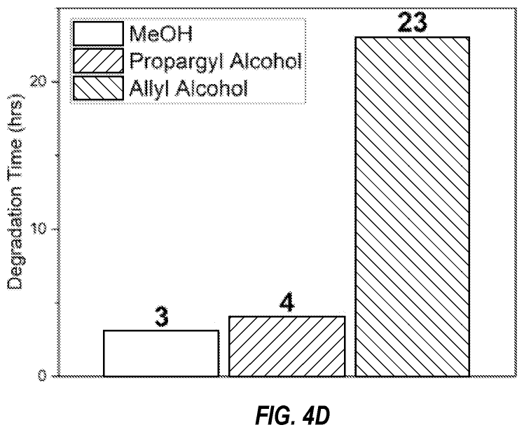

This allowed all reactants to be consumed. The reaction scheme is shown in FIG. 4A.

In this example, robust structure-property relationships were observed by copolymerizing various types and amounts of PHMEA. Four types of PHMEA were synthesized, including mono-methyl phthalate (Me), mono-ethyl phthalate (Et), mono-n-butyl phthalate (Bu), and mono-n-hexyl phthalate (Hex), by reacting PHA with excess amounts of alcohol at 80° C., without the presence of a catalyst. FTIR confirmed that the polymerization reaction was complete. As shown in Table 1, the Tg's consistently decreased when the substituent group increased in size. For example, from PH-0.6 Me, PH-0.6 Et, PH-0.6 Bu, to PH-0.6 Hex, the Tg decreased from 89° C., 86° C., 76° C., to 73° C., respectively. Also, when more PHMEA was added for copolymerization, the Tg decreased consistently. For example, from PH-0.2 Me to PH-0.4 Me to PH-0.6 Me, the Tg decreased from 112° C., 94° C., to 89° C., respectively. Interestingly, the rubbery modulus also decreased consistently from 6.2 MPa, to 3.0 MPa, to 1.5 MPa, respectively. Since the PHMEA is a monofunctional monomer during the tertiary polymerization reaction, it terminates a propagating chain. In network polymers, the rubbery modulus is proportional to crosslinking density. Applicant observed that by choosing the substituent group (e.g., the length of the alkyl group on the PHMEA) and the crosslinking density, one could precisely tune the material properties of the phthalate-based network polyester that results. Rubber modulus as reported in Table 1 was determined by the storage modulus at Tg+40° C.

TABLE 1

| | Ratio of | Tg | |
|---|---|---|---|
| Sample | [epoxy group]:[anhydride]:[monoacid] | (° C.) | Modulus |
| PH-0 | 2:1:0 | 133 | 13.1 |
| PH-0.2Me | 2.2:1:0.2 | 112 | 6.2 |
| PH-0.4Me | 2.4:1:0.4 | 94 | 3.0 |
| PH-0.6Me | 2.6:1:0.6 | 89 | 1.5 |
| PH-0.2Et | 2.2:1:0.2 | 108 | 7.1 |
| PH-0.4Et | 2.4:1:0.4 | 94 | 2.9 |
| PH-0.6Et | 2.6:1:0.6 | 86 | 1.3 |
| PH-0.4Bu | 2.4:1:0.4 | 80 | 1.4 |
| PH-0.6Bu | 2.6:1:0.6 | 76 | 0.8 |
| PH-0.2Hex | 2.2:1:0.2 | 104 | 6.0 |
| PH-0.4Hex | 2.4:1:0.4 | 80 | 1.2 |
| PH-0.6Hex | 2.6:1:0.6 | 73 | 1.4 |

### Example 3

It was hypothesized that reduced crosslinking could facilitate the improved transport of reagents to accelerate depolymerization and lower the required reaction temperature. Depolymerization of the DGPA-PHA binary polymer at room temperature (23° C.) was incomplete, even after a few days. In contrast, depolymerization of the tertiary PH-0.6 Me polymer was complete within 13 h at this same temperature. In both cases, samples were weighed at various times to monitor the course of degradation, as shown in FIG. 4B. By controlling the crosslinking density, network polyesters can be advantageously depolymerized at relatively low temperature, in a reasonable time frame (e.g., less than 24 hours, less than 18 hours, less than 15 hours, less than 12 hours, less than 10 hours, less than 8 hours, less than 6 hours, less than 5 hours, or less than 4 hours). The faster degradation times are more easily achieved at somewhat elevated temperatures. The degraded product from the tertiary PH-0.6Me was advantageously found to be the same dimethyl phthalate degradation product illustrated in FIG. 3.

### Example 4

Applicant next experimented with improving the depolymerization efficiency by using various alkali metal carbonate catalysts. While Li₂CO₃ and Na2CO₃ showed some reactivity, Rb₂CO₃ and Cs₂CO₃ resulted in faster depolymerization than K₂CO₃. In these experiments, the molar ratio of carbonate salts to methanol was fixed at 1:400. More generally speaking, the molar ratio of carbonate salt to alcohol may be from 1:100 to 1:1000, from 1:200 to 1:600, or from 1:300 to 1:500. As shown in FIG. 4C, mass losses of the polymer were consistently more rapidly as a heavier cation atom was used as the catalyst. Using Rb₂CO₃ and Cs₂CO₃, complete depolymerization was achieved at 11 h and 9 h, respectively, at 23° C. The improved depolymerization rate is likely due to the more efficient activation of carbonyl groups on the polyesters by the heavier cations.

### Example 5

Since a singular degradation product is formed in the contemplated embodiments, this example sought to alter the resulting degradation product to produce a functionalized ester, using functional alcohols for the degradation. Unsaturated alcohols including allyl alcohol (allyl-OH) and propargyl alcohol (propargyl-OH), were used for their subsequent reactivity in other polymerization reactions (FIG. 4A). It was noticed that allyl-OH and propargyl-OH were less efficient in the depolymerization of the tertiary PH-0.6 Me polymer than was methanol, so a slightly elevated temperature of 50° C. was used. Complete depolymerization was observed at such temperatures within 3 h, 4 h, and 23 h when methanol, propargyl-OH, and allyl-OH were used as the alcoholic reagents in neat conditions, respectively (FIG. 4D). With allyl-OH, the degraded product was confirmed to be diallyl phthalate (“DAPH”) by FTIR and 1 H NMR. With propargyl-OH, also using FTIR and ¹H NMR, the degraded product was confirmed to be dipropargyl phthalate (“DPPH”).

### Example 6

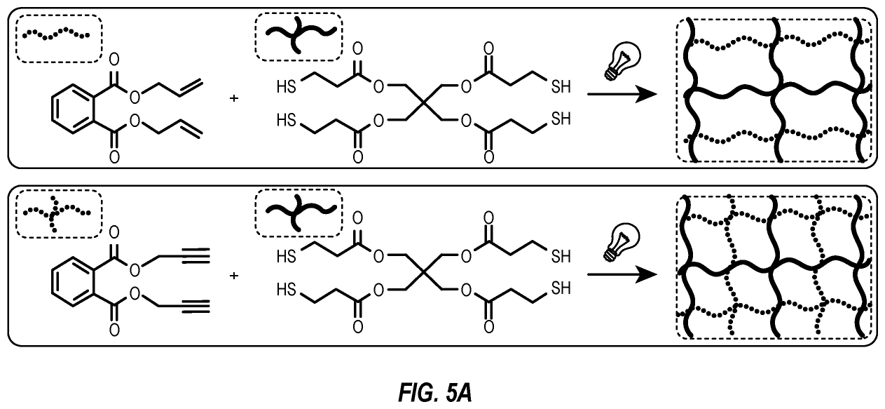

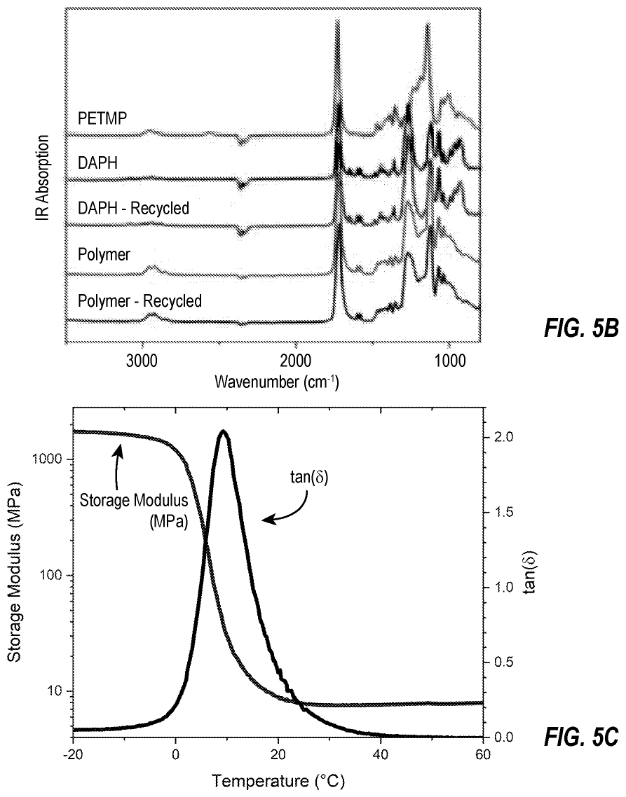

The two unsaturated degradation product monomers were used to obtain photopolymers based on free-radical mediated thiol-ene reactions. Thiol-ene photopolymers have emerged as a robust platform to fabricate various coatings, biomaterials, and polymers for stereolithographic 3D printing. A DAPH and a tetrafunctional thiol, pentaerythritol tetra(3-mercaptopropionate) (“PETMP”), with a stoichiometric amount of thiol and alkene groups were prepared (FIG. 5A). 1 wt % of a photoinitiator (e.g., diphenyl(2,4,6-trimethylbenzoyl)phosphine oxide (“TPO”) was used to catalyze the photopolymerization reaction, which was shown to be completed as FTIR spectra of the alkene and thiol peaks disappeared in the polymer (FIG. 5B). Next, a DPPH-PETMP polymer with the stoichiometric functionality between alkyne and thiol groups, where one alkyne group reacts with two thiol groups was prepared. The recycled DAPH-PETMP showed a Tg of 10° C. (FIG. 5C). By simply controlling the functionality used in the depolymerization of network polymers, one can tune the materials properties of the upcycled photopolymer.

### Example 7

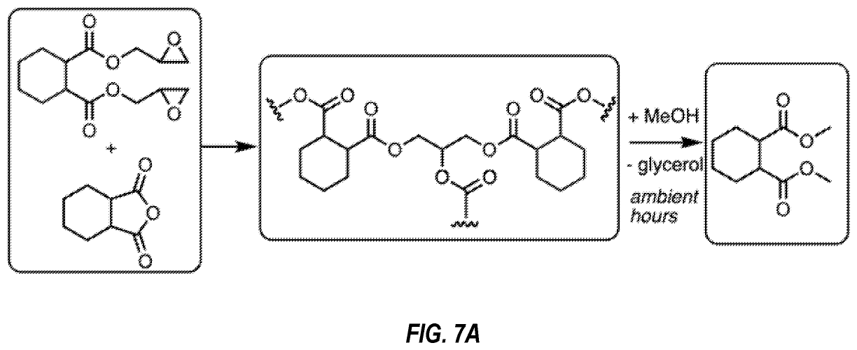

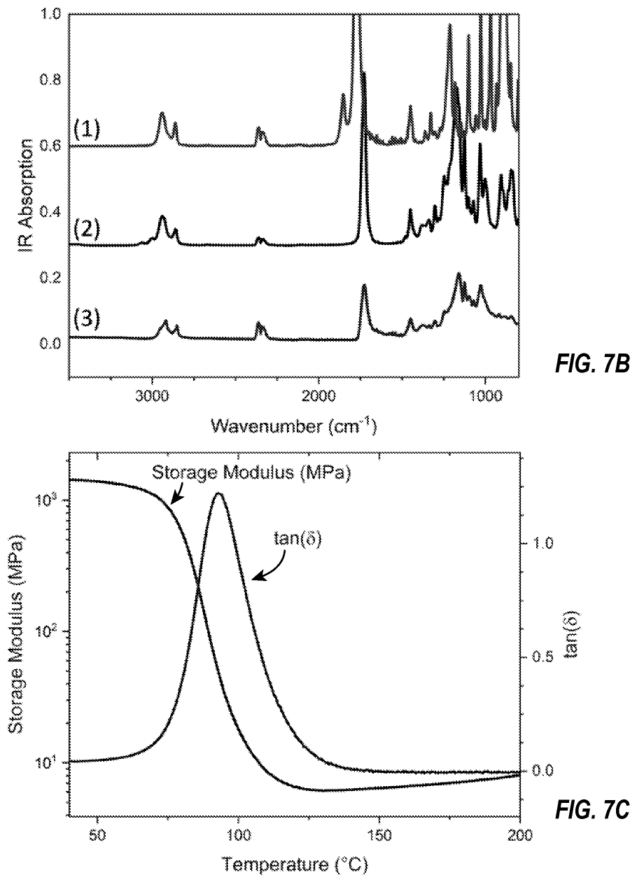

Besides aromatics, aliphatic carboxylates are also important feedstocks for synthesizing commodity polymers, including polyester-based polyols, polyurethanes, polyamides, and multifunctional (meth)acrylates. To further demonstrate the structural similarity as a platform approach for the circular use of aliphatic carboxylates, the present example employs 1,2-cyclohexane dicarboxylate. As shown in FIG. 7A, a stoichiometric amount of diglycidyl 1,2-cyclohexanedicarboxylate (CH-epoxy) and 1,2-cyclohexanedicarboxylic anhydride (CH-anhydride) were processed similarly to the phthalate system. The resulting polymer was glassy, with a Tg of 93° C. and a rubbery modulus of 6.2 MPa (FIG. 7C). Surprisingly, degradation of the aliphatic network polyester can be quickly and efficiently achieved using K₂CO₃ as the catalyst at room temperature. The formation of dimethyl esters was confirmed by FTIR spectra (FIG. 7B).

### Example 8

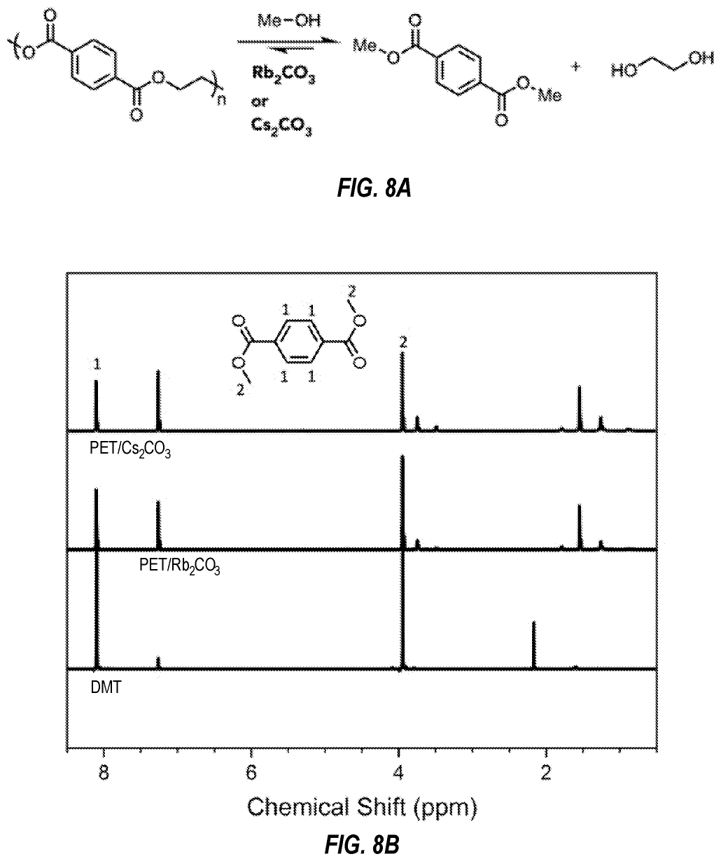

Since accelerated degradation of phthalate-based network polyesters was observed when using Rb₂CO₃ or Cs₂CO₃ rather than K₂CO₃, this example tested the suitability of Rb₂CO₃ or Cs₂CO₃ for the degradation of PET. As shown in FIGS. 8A-8B, PET powder was suspended in a large excess amount of methanol, using 10 mol % of Rb₂CO₃ (with respect to the repeating monomer units in PET). It was observed that the PET powder disappeared after 24 h under ambient conditions. These results confirmed that alkali metal carbonate salts effectively catalyze transesterification reactions, broadly applicable to several polyester substrates.

Recyclable network polymers are emerging as a key component of the circular economy of materials. Applicant has demonstrated that recyclability is enhanced with introducing structural similarity by employing monomers derived from the same carboxylate core or backbone. Applicant has also demonstrated efficient depolymerization of the network polyesters using inexpensive, non-toxic catalysts, at low temperature. Such depolymerization can be completed in less than 10 h at room temperature (23° C.) and atmospheric pressure. Both the inexpensive catalyst and ambient reaction conditions will facilitate implementation in industry by reducing the cost associated with such processes. Further, the structural similarity in the monomer components both before polymerization and after degradation enables obtaining functional molecules through one-pot, one-step depolymerization using functional reagents such as unsaturated alcohols.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including within the claims, shall be inclusive and/or open-ended, shall have the same meaning as the word “comprising” and variants thereof (e.g., “comprise” and “comprises”), and do not exclude additional un-recited elements or method steps, illustratively. Unless defined otherwise, all technical and scientific terms used herein have the same meaning as commonly understood by one of ordinary skill in the art to which the present disclosure pertains.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. As used herein, the term “between” includes any referenced endpoints. For example, “between 2 and 10” includes both 2 and 10.

Disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure. Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Accordingly, the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A polyester formed from epoxy and anhydride monomers where both the epoxy and anhydride monomers include a cyclic backbone having dicarboxylate groups;
so that when degraded with an alkali metal carbonate catalyst, a single cyclic monomer results, which cyclic monomers can be repolymerized, to produce a new polymer.

2. The polyester of claim 1, wherein the cyclic backbone comprises one of:
(i) a phthalic or other aromatic structure having dicarboxylate groups; or
(ii) a cycloaliphatic structure having dicarboxylate groups.

3. The polyester of claim 1, wherein both the epoxy and anhydride monomers include phthalic or other aromatic structures.

4. The polyester of claim 1, wherein both the epoxy and anhydride monomers include cyclohexane structures.

5. The polyester of claim 1, wherein the polyester does not include a polymerization product of a dicarboxylate and a diol (e.g., PET).

6. The polyester of claim 5, wherein the polyester does not include polyethylene terephthalate (“PET”).

7. A method for recycling or upcycling a polyester formed from epoxy and anhydride monomers, where both the epoxy and anhydride monomers include:
(i) a phthalic or other aromatic structure having dicarboxylate groups; or
(ii) a cycloaliphatic structure having dicarboxylate groups; or
(iii) another cyclic structure having dicarboxylate groups; and
degrading the polyester by contacting the polyester with a degradation composition including an alcohol and at least one of an alkali metal catalyst or an alkaline earth metal catalyst at a temperature of no more than about 60° C., so as to produce a single phthalic or other aromatic monomer or a single cycloaliphatic monomer or other cyclic monomer, wherein the resulting single phthalic monomer, single aromatic monomer or single cycloaliphatic monomer or other cyclic monomer can be repolymerized to produce a new polymer.

8. The method of claim 7, wherein depolymerization degradation is carried out at a temperature of no greater than about 50° C.

9. The method of claim 7, wherein depolymerization degradation is carried out at a temperature of no greater than about 35° C. The method of claim 7, wherein the alcohol comprises a C₁-C₆ alcohol.

11. The method of claim 10, wherein the alcohol comprises a C₁-C₄ alcohol.

12. The method of claim 7, wherein the alcohol comprises methanol.

13. The method of claim 7, wherein depolymerization degradation is carried out in the presence of an alkaline earth metal carbonate or alkali metal carbonate other than potassium carbonate.

14. The method of claim 13, wherein depolymerization degradation is carried out in the presence of cesium carbonate. The method of claim 13, wherein depolymerization degradation is carried out in the presence of rubidium carbonate.

16. The method of claim 7, wherein depolymerization degradation is carried out in the presence of potassium carbonate.

17. The method of claim 7, wherein the alcohol comprises an unsaturated alcohol such that the new polymer is a photopolymer.

18. A method for manufacturing a polyester, the method comprising:
providing epoxy and anhydride monomers, where both the epoxy and anhydride monomers include:
(i) a phthalic or other aromatic structure having dicarboxylate groups; or
(ii) a cycloaliphatic structure having dicarboxylate groups; or
(iii) another cyclic structure having dicarboxylate groups; and
polymerizing the epoxy and anhydride monomers to form a polyester.

19. The method of claim 18, wherein both the epoxy and anhydride monomers include a phthalic structure or cyclohexane cycloaliphatic structure.

20. The method of claim 18, wherein the polymerization further includes a tertiary co-monomer, the tertiary co-monomer being monofunctional, so as to terminate a polymerizing chain.
